(19) United States
(12) Patent Application Publication
(10) Pub. No.: US 2017/0337855 A1
(43) Pub. Date: Nov. 23, 2017

(54) STAKING SYSTEM

(71) Applicant: Spencer Gifts LLC, Egg Harbor Township, NJ (US)

(72) Inventors: Mike JALANDONI, Stow, OH (US); Matthew PEIRCE, Philadelphia, PA (US)

(21) Appl. No.: 15/590,171

(22) Filed: May 9, 2017

Related U.S. Application Data
(60) Provisional application No. 62/337,687, filed on May 17, 2016.

(51) Int. Cl. G09F 7/18; E04H 13/00; G09F 19/22

(52) U.S. Cl. CPC G09F 7/18; G09F 19/228; E04H 13/003; G09F 2007/1856

(57) ABSTRACT

A simulative system includes a tombstone replica and at least one receiver peg receivable in a non-rotatable manner within a corresponding at least one slot embedded in an underside of the tombstone replica. The at least one receiver peg has a non-circular cross-section. A corresponding at least one stake is removably, slidably receivable in a non-rotatable manner within the at least one receiver peg. The at least one stake includes an upper, male connector portion for receipt into a respective receiver peg and a lower, post section having a pointed tip for driving into a ground surface.

### CROSS-REFERENCE TO RELATED APPLICATIONS

This application claims priority from U.S. Provisional Patent Application No. 62/337,687, titled “Improved Staking System”, filed on May 17, 2016, the entire contents of which are incorporated by reference herein.

### BACKGROUND OF THE INVENTION

The present invention is generally directed to a staking system for securing an item into the ground, and, particularly, a staking system for securing a fake tombstone into the ground.

Staking systems for securing items into the ground are well known, such as, for example, H-shaped stakes. One drawback of such conventional staking systems is that they are flimsy and are generally only usable to support light items in the upright position above the ground, e.g., realtor signs. Another drawback of conventional staking systems is that they are easily twisted/rotated by wind force.

Therefore, it would be advantageous to manufacture a sturdy staking system, capable of supporting heavier items in the upright position above the ground, and capable of preventing the supported item from spinning from wind force.

### BRIEF SUMMARY OF THE INVENTION

Briefly stated, one aspect of the present invention is directed to a simulative tombstone staking system. The simulative system comprises a tombstone replica and at least one receiver peg receivable in a non-rotatable manner within a corresponding at least one slot embedded in an underside of the tombstone replica. The at least one receiver peg has a non-circular cross-section. A corresponding at least one stake is removably, slidably receivable in a non-rotatable manner within the at least one receiver peg. The at least one stake includes an upper, male connector portion for receipt into a respective receiver peg and a lower, post section having a pointed tip for driving into a ground surface.

Another aspect of the present invention is directed to a simulative tombstone staking system comprising a tombstone replica and at least one receiver peg having a non-circular cross-section. The at least one receiver peg is shaped and dimensioned to mate, in a non-rotatable manner, with a corresponding at least one slot embedded in an underside of the tombstone replica. A corresponding at least one stake has an upper, male connector portion and a lower, post section. The upper, male connector portion has a non-circular cross-section and is shaped and dimensioned to removably mate, in a non-rotatable manner, with a corresponding receiver peg. The lower, post section has a pointed tip for driving into a ground surface.

### BRIEF DESCRIPTION OF THE DRAWINGS

The foregoing summary, as well as the following detailed description of the invention will be better understood when read in conjunction with the appended drawings. It should be understood, however, that the invention is not limited to the precise arrangements and instrumentalities shown. In the drawings:

FIG. 1 is a perspective view of a staking system, according to an embodiment of the invention, with one stake assembled to a fake tombstone and another stake unassembled;

FIG. 2 is a partial perspective view of the staking system of FIG. 1;

FIG. 3 is a bottom plan view of the fake tombstone of FIG. 1, showing receiver pegs of the staking system embedded into the fake tombstone without the respective stakes inserted therein;

FIG. 4 is an enlarged, partial perspective view of staking system of FIG. 1, showing a single receiver peg and stake set; and

FIG. 5 is a bottom plan view of an alternative embodiment of a fake tombstone, showing the receiver pegs of the staking system fully embedded into the fake tombstone without the respective stakes inserted therein.

### DETAILED DESCRIPTION OF THE INVENTION

Certain terminology is used in the following description for convenience only and is not limiting. The words “lower,” “bottom,” “upper” and “top” designate directions in the drawings to which reference is made. The words “inwardly,” “outwardly,” “upwardly” and “downwardly” refer to directions toward and away from, respectively, the geometric center of the staking system, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

It should also be understood that the terms “about,” “approximately,” “generally,” “substantially” and like terms, used herein when referring to a dimension or characteristic of a component of the invention, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

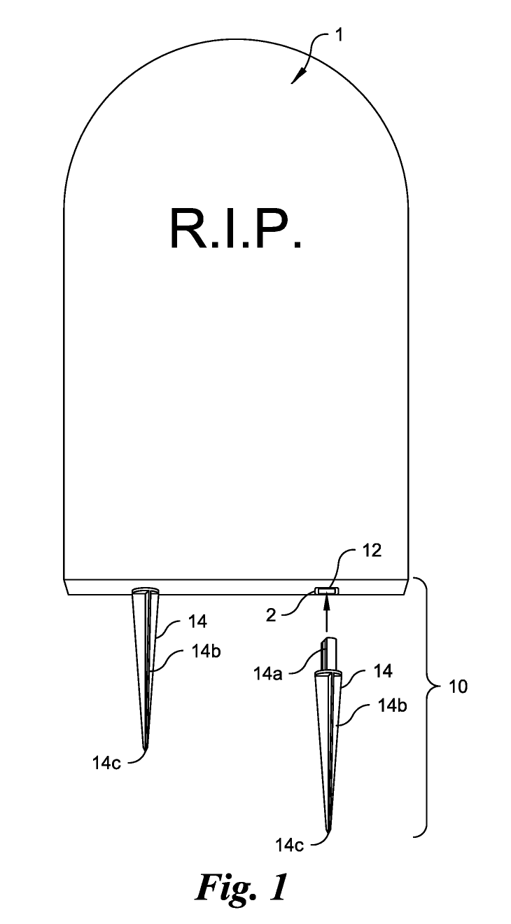

Referring to the drawings in detail, wherein like numerals indicate like elements throughout, there is shown in FIG. 1 a staking system, generally designated 10, in accordance with an embodiment of the present invention. In the illustrated embodiment, the staking system 10 is utilized with a fake tombstone (tombstone replica) 1, e.g., a tombstone constructed of foam or other material for Halloween or other decoration. However, as should be understood by those of ordinary skill in the art, the present disclosure is not so limited and the staking system 10 may be utilized with numerous different items, to support an item in an upright position above the ground (not shown).

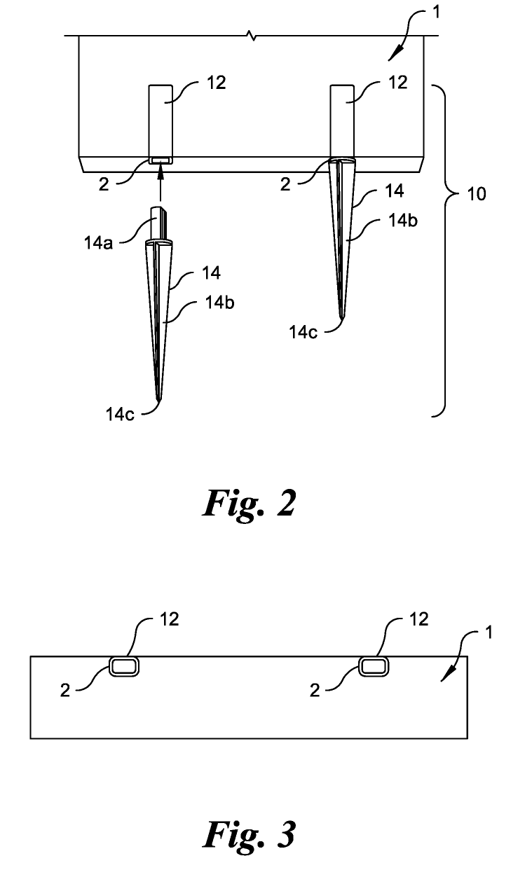

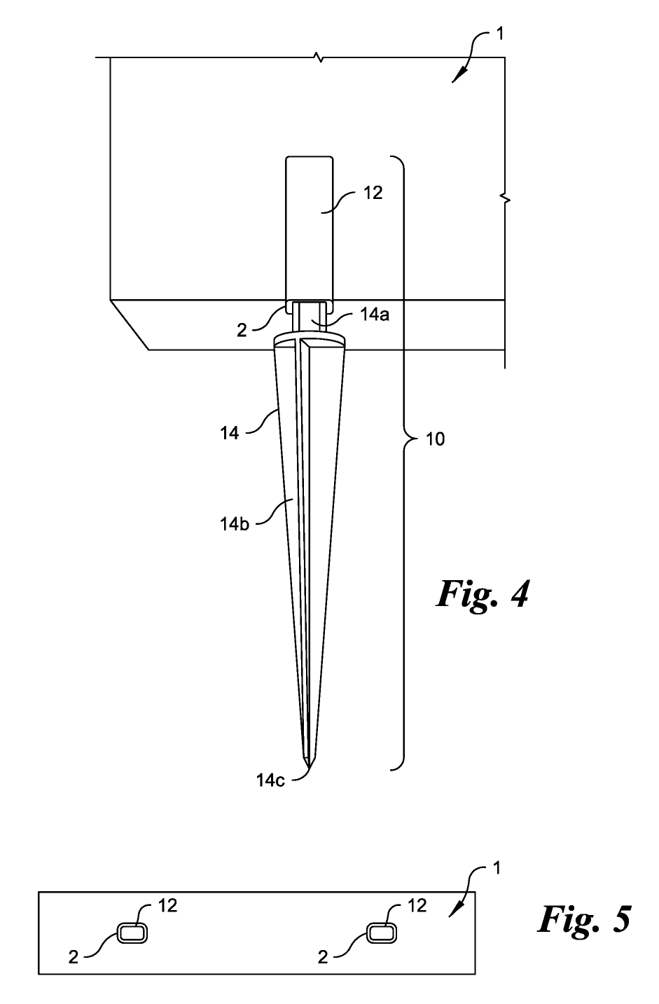

As shown in FIGS. 1-4, the staking system 10 includes at least one, preferably polymeric, receiver peg 12 and a corresponding at least one, preferably polymeric, stake 14. In the illustrated embodiment of FIG. 4, for example, a staking system 10 with a single receiver peg 12 and corresponding stake 14 is shown, and in FIGS. 1-3 a staking system 10 including two receiver pegs 12 and two corresponding stakes 14 is shown. As should be understood by those of ordinary skill in the art, the present disclosure is not so limited, however, as the staking system 10 may also include more than two receiver peg 12 and corresponding stake 14 sets.

As shown best in FIGS. 3 and 5, the receiver peg 12 has a non-circular cross-section. In the illustrated embodiment, the cross-section of the receiver peg 12 is generally rectangular or square, but the disclosure is not so limited. Each receiver peg 12 is fittingly received and secured within an opening or slot 2 in the base of the tombstone 1, and, therefore, the receiver peg 12 is embedded within the tombstone 1 when assembled. In the embodiment of FIG. 3, the slot 2 has an open rear side. Accordingly, the receiver peg 12 is not enveloped by tombstone 1 at a rear side thereof. In the illustrated embodiment of FIG. 3, the rear side of the receiver peg 12 is substantially flush with the rear side of the tombstone 1. Alternatively, the receiver peg 12 may be fully embedded within the tombstone 1, i.e., fully enveloped by the tombstone 1 on all sides other than the open base end of the receiver peg 12, as shown in FIG. 5.

As shown, the slot 2 is shaped and dimensioned to complement the exterior geometry of the receiver peg 12 to prevent rotation between the receiver peg 12 and the tombstone 1. The receiver peg 12 may be interferingly fit into the slot 2, for example, or, alternatively, may be secured into the slot 2 via other methods, such as, for example, via adhesive or the like. As should also be understood, the cross-section of the receiver peg 12 may take the form of any shape that may be embedded in a non-rotational manner into the tombstone 1, such as, for example, without limitation, a keyed engagement or the like. Alternatively, where more than one receiver peg 12 and corresponding stake 14 set is used, the tombstone 1 will not rotate relative to the staking system 10, even if the individual receiver pegs 12 are rotatably embedded within the tombstone 1.

Turning to FIGS. 1, 2 and 4, the stake 14 includes an upper, male connector portion 14a and a lower post section 14b, preferably having a pointed tip 14c for driving into the ground (not shown). The male connector portion 14a is dimensioned to be removably, slidably received within the non-circular receiver peg 12 in a non-rotatable manner. For example, in the illustrated embodiment, the male connector portion 14a is shaped and dimensioned to fittingly mate with the receiver peg 12.

In use the receiver peg 12 is embedded into the slot 2 of the tombstone 1. Beforehand or afterward, the male connector portion 14a of the stake 14 is inserted into the receiver peg 12. Beforehand or afterward, the lower post section 14b of the stake 14 is driven into the ground via the pointed tip 14c. Because the stake 14 is not rotatable relative to the receiver peg 12 and the receiver peg 12 is not rotatable relative to the tombstone 1, the tombstone 1 is, therefore, not rotatable relative to the stake 14, which is driven into the ground. For additional support, multiple receiver peg 12 and corresponding stake 14 sets may be employed.

It will be appreciated by those skilled in the art that changes could be made to the embodiment(s) described above without departing from the broad inventive concept thereof. For example, while the stake system 10 shown and described is preferably made of a polymeric material, all or portions of the stake system 10 could be made of some other suitable material, such as, for example, without limitation, metal, metal alloy, wood, coated fiber board or the like. It is understood, therefore, that this invention is not limited to the particular embodiment(s) disclosed, but it is intended to cover modifications within the spirit and scope of the present invention, as set forth in the appended claims.

We claim:

1. A simulative tombstone staking system comprising:
a tombstone replica;
at least one receiver peg receivable in a non-rotatable manner within a corresponding at least one slot embedded in an underside of the tombstone replica, the at least one receiver peg having a non-circular cross-section; and
a corresponding at least one stake removably, slidably receivable in a non-rotatable manner within the at least one receiver peg, the at least one stake including an upper, male connector portion for receipt into a respective receiver peg and a lower, post section having a pointed tip for driving into a ground surface.

2. The simulative tombstone staking system of claim 1, wherein the at least one receiver peg is polymeric and the at least one stake is polymeric.

3. The simulative tombstone staking system of claim 1, comprising two slots, two receiver pegs and two stakes.

4. The simulative tombstone staking system of claim 1, wherein the at least one receiver peg is shaped and dimensioned to be substantially fittingly, slidably received within the corresponding at least one slot in the underside of the tombstone replica in an assembled configuration.

5. The simulative tombstone staking system of claim 1, wherein the at least one receiver peg is embedded within the tombstone replica in an assembled configuration.

6. The simulative tombstone staking system of claim 5, wherein the at least one receiver peg is fully enveloped by the tombstone replica on all sides other than an open base end of the receiver peg.

7. The simulative tombstone staking system of claim 1, wherein the male connector portion of the at least one stake is shaped and dimensioned to be substantially fittingly, slidably received within the corresponding at least one receiver peg in an assembled configuration.

8. The simulative tombstone staking system of claim 1, wherein the tombstone replica is constructed of a foam material.

9. A simulative tombstone staking system comprising:
a tombstone replica;
at least one receiver peg having a non-circular cross-section, the at least one receiver peg being shaped and dimensioned to mate, in a non-rotatable manner, with a corresponding at least one slot embedded in an underside of the tombstone replica; and
a corresponding at least one stake having an upper, male connector portion and a lower, post section, the upper, male connector portion having a non-circular cross-section and being shaped and dimensioned to removably mate, in a non-rotatable manner, with a corresponding receiver peg, and the lower, post section having a pointed tip for driving into a ground surface.

10. The simulative staking system of claim 9, wherein the at least one receiver peg is polymeric and the at least one stake is polymeric.

11. The simulative tombstone staking system of claim 9, wherein the tombstone replica is constructed of a foam material.

12. The simulative tombstone staking system of claim 9, wherein the at least one receiver peg is fully enveloped by the tombstone replica on all sides other than an open base end of the receiver peg, in an assembled configuration.
